(19) United States
(12) Patent Application Publication
(10) Pub. No.: US 2003/0190467 A1
(43) Pub. Date: Oct. 9, 2003

(54) Adhesive material based on block copolymers having a p(b)-p(a/c)-p(b) structure

(76) Inventors: Marc Husemann, Hamburg (DE); Stephan Zollner, Hamburg (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(21) Appl. No.: 10/343,182

(22) PCT Filed: Jul. 27, 2001
(86) PCT No.: PCT/EP01/08736

(30) Foreign Application Priority Data
Jul. 28, 2000 (DE) 100 36 804.2

(51) Int. Cl. B32B 7/12

(52) U.S. Cl. 428/354

(57) ABSTRACT

The invention relates to an adhesive material based on block copolymers of general type P(B)-P(A/C)-P(B). wherein each block copolymer consists of a central copolymer block P(A/C) and terminal polymer block P(B). The invention is characterised in that P(A/C) represents a copolymer from monomers A anid C, which has a glass transition temperature of 0° C.-80° C. wherein component C contains at least one functional group which behaves in an inert manner in a radical polymerisation reaction, and which is used to increase the cohesion of said block copolymer: P(B) represents a polymer from monomers B, which has a glass transition temperature of 20° C.-175° C.; the polymer-block P(B) is insoluble in the copolymer-block P(A/C), and P(A/C) are unmixable.

The invention relates to pressure sensitive adhesives based on block copolymers of the general type P(B)-P(A/C)-P(B).

In the field of pressure sensitive adhesives (PSAs) continuing technological developments in the coating technique mean that there is an ongoing need for new developments. Within the industry, hotmelt processes with solventless coating technology are of increasing importance in the preparation of PSAs, since the environmental regulations are becoming ever more stringent and the prices of solvents continue to rise. Consequently, solvents are to be eliminated as far as possible from the manufacturing operation for PSA tapes. The associated introduction of the hotmelt technology is imposing ever-greater requirements on the adhesives. Acrylic PSAs in particular are the subject of very intensive investigations aimed at improvements. For high-level industrial applications, polyacrylates are preferred on account of their transparency and weathering stability. In addition to these advantages, however, these acrylic PSAs must also meet stringent requirements in respect of shear strength and bond strength. This profile of requirements is met by polyacrylates of high molecular weight and high polarity, with subsequent efficient crosslinking. These high shear strength, polar PSAs, however, possess the disadvantage that they are not well suited to the hotmelt extrusion operation, because high application temperatures are necessary and because, furthermore, shearing within the extruder lowers the molecular weight of the polymer. This damage significantly reduces the level of the adhesive properties. The bond strength and the tack are generally low, since owing to the polar fractions in the adhesives the glass transition temperature is relatively high. The shear strengths of the hotmelt-coated acrylic PSAs, in particular, fall distinctly in comparison to the original, solvent-coated PSA. At the present time, therefore, different concepts aimed at reducing the flow viscosity and thereby facilitating extrusion coating of these PSAs are being investigated.

The industry is pursuing a variety of concepts for achieving this objective. One possibility is the highly efficient crosslinking of a low viscosity, apolar acrylic adhesive not until it is on the backing. Acrylates containing electron donating groups are copolymerized and, during crosslinking by UV or EBC (EBC: electron beam curing), they stabilize free radicals that are formed. Examples thereof are tertiary amine monomers [WO 96/35725], tertiary butylacrylamide monomer [U.S. Pat. No. 5,194,455], and tetrahydrofuryl acrylates [EP 0 343 467 B1]. A further efficient crosslinking concept is the copolymerization of UV photoinitiators into the polyacrylate chain. For example, benzoin acrylate has been used as a comonomer and the crosslinking has been conducted on the backing using UV light [DE 27 43 979 A1]. In U.S. Pat. No. 5,073,611, on the other hand, benzophenone and acetophenone are used as copolymerizable monomers.

Very efficient chemical crosslinking takes place by radiation in the case of polyacrylates containing double bonds [U.S. Pat. No. 5,741,543].

Styrene-isoprene-styrene (SIS) block copolymers, in contrast, are widespread elastomers for hotmelt-processable PSAs [preparation processes: U.S. Pat. Nos. 3,468,972; 3,595,941; application in PSAs: U.S. Pat. Nos. 3,239,478; 3,935,338]. Good processing properties are achieved by virtue of a relatively low molecular weight and by virtue of a specific morphology [EP 0 451 920 B1]. These PSAs can be crosslinked very effectively with UV light in the presence of photoinitiators or with electron beams (EB), since the middle blocks contain a large number of double bonds.

Nevertheless, these elastomers possess disadvantages, such as, for example, severe aging under UV light (in other words in daylight as well) and in an atmosphere containing oxygen/ozone. Another property which is very adverse for application is the relatively low thermal shear strength. These PSAs are therefore not suitable for relatively long-term outdoor bonds and for applications in relatively high temperature ranges. The same also applies to other block copolymers which possess a middle block containing at least one double bond [U.S. Pat. No. 5,851,664].

One solution to the problem of aging, hotmelt processability, high cohesion, and efficient chemical crosslinking by radiation is provided by the combination of SIS polymers with polyacrylates. Accordingly, the Patent US H1,251 describes, for hotmelt applications, diene copolymers containing acrylate, although these copolymers are likewise subject to aging, owing to the large number of double bonds which remain.

U.S. Pat. No. 5,314,962 describes A-B-A block copolymers as elastomers for adhesives, but these possess only A domain formation as a cohesion-forming criterion and therefore lack great shear strength, especially at high temperatures.

EP 0 921 170 A1 describes A-B-A block copolymers which have been modified with additions of resin. Here, no crosslinking has been carried out, so that in this case as well the shear strength of the PSAs described is very low.

It is an object of the invention, therefore, to provide improved pressure sensitive adhesives based on polyacrylate which exhibit the disadvantages of the prior art only to a reduced extent, if at all, and with which it is possible to achieve an increase in the cohesion, and which, in particular, are suitable for processing by the hotmelt process and for use as hotmelt adhesives, without losing the properties which are advantageous for use as a PSA.

This object is achieved, surprisingly and unforeseeably, by the pressure sensitive adhesive of the invention as specified in the main claim. The subclaims relate to improved embodiments of these pressure sensitive adhesives, to a process for preparing them, and to their use.

The main claim relates accordingly to a pressure sensitive adhesive based on block copolymers of the general type P(B)-P(A/C)-P(B), each block copolymer being composed of one middle copolymer block P(A/C) and two end polymer blocks P/(B), where

P(A/C) represents a copolymer of the monomers A and C which possesses a glass transition temperature of from 0° C. to −80° C., component C possessing at least one functional group which behaves inertly in a free-radical polymerization reaction and which serves to raise the cohesion of the block copolymer,

P(B) represents a polymer of the monomers B which possesses a glass transition temperature of from 20° C. to 175° C.,

the polymer block P(B) is insoluble in the copolymer block P(A/C), and the blocks P(B) and P(A/C) are immiscible.

Very advantageously in the sense of the presented invention, the cohesion-enhancing effect of the copolymer P(A/C) is brought about by bonds between the individual block polymers P(B)-P(A/C)-P(B), with the functional group of component C of one block copolymer macromolecule entering into interaction with a further block copolymer macromolecule.

Bonds of this kind in the inventive sense are all bonds ranging from purely physical forces of attraction through to bonds originating from a chemical reaction (for example, covalent bonds, ionic bonds, van der Waals bonds). It may be mentioned here that the function of forming bonds may also be served by interlinks, interloops, interhooks or the like between the macromolecules or side chains located thereon.

In one first advantageous embodiment of this invention component C contains at least one functional group which is capable of entering into dipole-dipole interactions and/or hydrogen bonds, and the functional group of component C brings about the enhancement in cohesion by means of such dipole-dipole interactions and/or hydrogen bonds, especially with further block copolymers. In this case, the glass transition temperature is raised in relation to component A.

A second very advantageous embodiment of the invention is provided by a pressure sensitive adhesive in which the function group of component C is able to bring about a crosslinking reaction, where appropriate only after prior activation, and the functional group of component C brings about the enhancement of cohesion by means of such crosslinking reactions.

The prior activation or initiation of crosslinking may advantageously take place by means of differences in the supply of energy.

In one variant of the pressure sensitive adhesive the functional group of component C that is capable of crosslinking is an unsaturated group which is capable of radiation-chemical crosslinking, in particular by means of crosslinking brought about by UV irradiation or by irradiation with electron beams.

Very advantageously in this case the crosslinking-capable functional group of component C is an unsaturated alkyl radical of 3 to 20 carbon atoms which contains at least one C—C double bond.

For acrylates modified with double bonds, allyl acrylate and acrylated cinnamic esters are especially advantageous in the sense of the invention.

In addition to acrylic monomers as component C it is also possible with great advantage to use vinyl compounds having double bonds which do not react during the (free-radical) polymerization. Particularly preferred examples are isoprene and butadiene.

In a further variant of the pressure sensitive adhesive modified by crosslinking groups, the crosslinking-capable functional group of component C is a group which is capable of a crosslinking reaction by virtue of the influence of thermal energy.

For these two variants it has been found very advantageous to choose, for the crosslinking-capable functional group of component C, a hydroxyl, a carboxyl, an epoxy, an acid amide, an isocyanato or an amino group.

As monomers C it is preferred to use acrylic monomers or vinyl monomers which, alone or in combination with monomer A, lower the glass transition temperature of the copolymer block P(A/C) to below 0° C. In one advantageous variant of the process of the invention acrylic monomers are used, especially those corresponding to the following general formula:

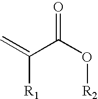

where R₁═H or CH₃ and the radical —OR₂ represents or includes the functional group for enhancing the cohesion of the pressure sensitive adhesive.

Examples of component C are hydroxyethyl acrylate, hydroxypropyl acrylate, hydroxyethyl methacrylate, hydroxypropyl methacrylate, acrylic acid, methacrylic acid, methyl methacrylate, t-butyl acrylate, allyl alcohol, maleic anhydride, itaconic anhydride, itaconic acid, benzoin acrylate, acrylated benzophenone, acrylamides (such as, for example, N-t-butylacrylamide, N-isopropylacrylamide, dimethylacrylamide), and glyceridyl methacrylate, this list not being conclusive.

In this context it is preferred to choose:

a) for dipole-dipole interaction and/or hydrogen bond forming properties:

acrylic acid, methacrylic acid, itaconic acid, but also hydroxyethyl acetate, hydroxypropyl acetate, allyl alcohol, acrylamides, hydroxyethyl methacrylate, methyl methacrylate

b) for crosslinking with high energy radiation:

benzoin acrylate, acrylated benzophenone

c) for thermal crosslinking:

hydroxyethyl acrylate, hydroxypropyl acrylate, hydroxyethyl methacrylate, hydroxypropyl methacrylate, acrylic acid, methacrylic acid, allyl alcohol, maleic anhydride, itaconic anhydride, itaconic acid, glyceridyl methacrylate, but also all acrylamides.

With t-butyl acrylate and, for example, stearyl acrylate an additional increase in the glass transition temperature is produced. The resulting polymers have a relatively high molecular weight and a restricted mobility.

As monomer A it is advantageous to use acrylic monomers or vinyl monomers, with particular preference to those which, alone or in combination with monomer C, lower the glass transition temperature of the copolymer block P(A/C) to below 0° C.

As component A for the pressure sensitive adhesive of the invention it is very advantageous to use one or more compounds which may be described by the following general formula:

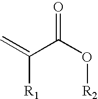

Here, R₁═H or CH₃, the radical R₂ is chosen from the group of the branched or unbranched, saturated alkyl groups having from 4 to 14 carbon atoms.

Acrylic monomers which are used preferentially as component A for the inventive pressure sensitive adhesive include acrylic and methacrylic esters with alkyl groups composed of from 4 to 14 carbon atoms, preferably from 4 to 9 carbon atoms. Specific examples, without wishing to be restricted by this list, are n-butyl acrylate, n-pentyl acrylate, n-hexyl acrylate, n-heptyl acrylate, n-octyl acrylate, n-nonyl acrylate, and branched isomers thereof, such as 2-ethylhexyl acrylate, for example.

As monomer A use is additionally made, optionally, of vinyl monomers from the following groups: vinyl esters, vinyl ethers, vinyl halides, vinylidene halides, vinyl compounds with aromatic rings and heterocycles in the α-position.

Here again, nonexclusive mention may be made of some examples: vinyl acetate, vinylformamide, vinylpyridine, ethyl vinyl ether, vinyl chloride, vinylidene chloride, acrylonitrile.

As component B it is preferred to choose monomers which are capable of forming a 2-phase domain structure with the copolymer blocks P(A/C). A prerequisite for this is the immiscibility of the blocks P(B) with the blocks P(A/C). Within the 2-phase domain structure regions are formed in which the P(B) blocks of different (and also, where appropriate, identical) chains mix with one another. These domains, as they are known, are embedded in a P(A/C) matrix. A 2-phase domain structure of this kind characteristically possesses two glass transition temperatures.

With the formation of two phases having different properties, hard blocks P(B) are obtained alongside soft blocks P(A/C).

Advantageous examples of compounds which can be used as component B are vinylaromatics, methyl methacrylates, cyclohexyl methacrylates, isobornyl methacrylates. Particularly preferred examples of component B are methyl methacrylate and styrene.

A further preferred characteristic of these block copolymers P(B)-P(A/C)-P(B) is that the molecular weight lies between 5,000 and 600,000 g/mol, more preferably between 10,000 and 300,000 g/mol. The fraction of the polymer blocks P(B) lies advantageously between 10 and 60 percent by weight of the entire block copolymer, more preferably between 15 and 40% by weight. The weight fraction of component C in relation to component A lies very advantageously between 0.1 and 20, more preferably between 0.5 and 5.

For preparing the block copolymers of the invention it is possible to make use of any controlled-growth polymerizations which proceed in accordance with free-radical mechanisms, such as, for example, ATRP (atom-transfer radical polymerization), polymerization controlled by nitroxide or TEMPO (2,2,6,6-tetramethyl-1-piperidinyloxy pyrrolidinyloxyl) and/or its derivatives, or polymerization by the RAFT process (rapid addition-fragmentation chain transfer). For the preparation it is possible, for example, to use a difunctional initiator which in one step initiates the (co)polymerization of the monomers A and C and then in a second step copolymerizes component B in order to introduce the end blocks (II), it being possible as an option to isolate the intermediate. I-R-I in the reaction equation which follows represents the difunctional initiator containing the functional groups I.

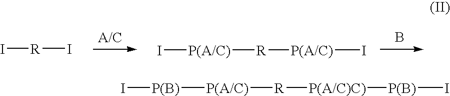

In addition, the triblock copolymer may be prepared by free-radical recombination of the macromonomers P(B)-P(A/C)* (III).

2P(B)-P(A/C)* →P(B)-P(A/C)-P(A/C)-P(B) (III)

For polymerizing the block copolymers it is possible with preference to use nitroxide regulators for free-radical control. The polymerization may be conducted in the presence of one or more organic solvents and/or in the presence of water or without solvent. It is preferred to use as little solvent as possible. The polymerization time, depending on conversion rate and temperature, is between 6 and 48 h.

In the case of solution polymerization, preferred solvents used are esters of saturated carboxylic acids (such as ethyl acetate), aliphatic hydrocarbons (such as n-hexane or n-heptane), ketones (such as acetone or methyl ethyl ketone), special boiling point spirit or mixtures of these solvents. For polymerization in aqueous media or in mixtures of organic and aqueous solvents, it is preferred to add emulsifiers and stabilizers for the polymerization. Polymerization initiators used include customary radical-forming compounds such as, for example, peroxides, azo compounds, and peroxosulfates. Mixtures of initiators are also outstandingly suitable. For free-radical stabilization use is made of nitroxides of type (IVa) or (IVb)

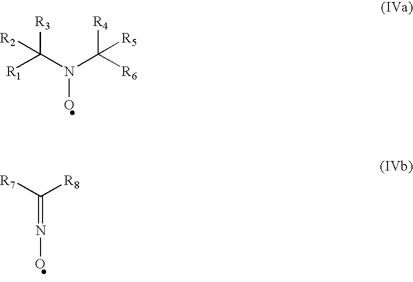

where R₁, R₂, R₃, R₄, R₅, R₆, R₇ and R₈ independently of one another denote the following compounds or atoms:

i) halides, such as chlorine, bromine or iodine, for example

ii) linear, branched, cyclic and heterocyclic hydrocarbons having 1-20 carbon atoms, which may be saturated, unsaturated, and aromatic,

iii) esters —COOR₉, alkoxides —OR₁₀ and/or phosphonates —PO(OR₁₁)₂, where R₉, R₁₀ or R₁₁ stand for radicals from group ii).

The compounds (IVa) or (IVb) may also be attached to polymer chains of any kind and may therefore be utilized for synthesizing the block copolymers, as macroradicals or macro regulators. Macromolecules of this kind may be formed, for example, during the polymerization operation.

For controlled regulation of the polymerization, it is more preferable to use compounds from the following list:

2,2,5,5-tetramethyl-1-pyrrolidinyloxyl (PROXYL), 3-carbamoyl-PROXYL, 2,2-dimethyl 4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL

2,2,6,6-tetramethyl-1-piperidinyloxy pyrrolidinyloxy (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl

N-tert-butyl-1-phenyl-2-methyl propyl nitroxide

N-tert-butyl-1-(2-naphthyl)-2-methyl propyl nitroxide,

N-tert-butyl-1-diethylphosphono-2,2,-dimethyl propyl nitroxide

N-tert-butyl-1-dibenzylphosphono-2,2-dimethyl propyl nitroxide

N-(1-phenyl-2-methylpropyl)-1-diethylphosphono-1-methyl ethyl nitroxide

di-t-butyl nitroxide

diphenyl nitroxide

T-butyl t-amyl nitroxide

As a further controlled polymerization method use is made of atom transfer radical polymerization (ATRP), in which case as initiator it is preferred to use monofunctional or difunctional secondary or tertiary halides and, for the obstruction of the halides, complexes of Cu, of Ni, of Fe, of Pd, of Pt, of Ru, of Os, of Rh, of Co, of Ir, of Cu, of Ag or of Au [EP 0 824 111; EP 0 826 698; EP 0 824 110; EP 0 841 346; EP 0 850 957]. The various possibilities of ATRP are described in U.S. Pat. No. 5,945,491, U.S. Pat. No. 5,854,364 and U.S. Pat. No. 5,789,487.

As a preferred variant, the RAFT process (reversible addition fragmentation chain transfer) is carried out. The process is described in detail in WO 98/01478 and WO 99/31144. Suitable with particular advantage for preparing block copolymers are trithiocarbonates [Macromolecules 2000, 33, 243-245], which in a first step randomly copolymerize monomers of type A and C and subsequently can be isolated or can be used directly for the subsequent polymerization of monomer B.

In order to prepare a pressure sensitive adhesive the block copolymers described so far are processed further in solution or from the melt. Suitable solvents are one or more organic solvents. In order to produce a pressure sensitive adhesive tape the block copolymer is advantageously modified with resins. Examples of resins which can be used include terpene resins, terpene phenol resins, C₅ and C₉ hydrocarbon resins, pinene resins, indene resins, and rosins, alone and also in combination with one another. In principle, however, it is possible to use all resins which are soluble in the corresponding polyacrylate P(A/C); reference may be made in particular to all aliphatic, aromatic, alkylaromatic hydrocarbon resins, hydrocarbon resins based on pure monomers, hydrogenated hydrocarbon resins, functional hydrocarbon resins, and also natural resins.

The weight fraction of the resins within the block copolymer is preferably between 0 and 50% by weight, more preferably between 20 and 40% by weight.

In addition, additives are optionally added in the course of the preparation and/or processing operation, such as aging inhibitors, compounding agents, light stabilizers, ozone protectants, fatty acids, plasticizers, nucleators, blowing agents, accelerators and/or various fillers (for example, carbon black, TiO₂, solid or hollow beads of glass or other materials, nucleators).

In one advantageous development, particularly for the second advantageous embodiment of the invention, crosslinker substances which are soluble in P(A/C) or compatible with P(A/C) are added. Examples of suitable crosslinkers include metal chelates, polyfunctional isocyanates, polyfunctional amines or polyfunctional alcohols. Polyfunctional acrylates may also be added advantageously as crosslinkers.

In one advantageous development for crosslinking with UV light, UV photoinitiators are added to the block copolymers. Useful photoinitiators which can be used to very good effect in the inventive sense are benzoin ethers, such as benzoin methyl ether and benzoin isopropyl ether, for example, substituted acetophenones, such as 2,2-diethoxyacetophenone (available as Irgacure 651 from Ciba Geigy), 2,2-dimethoxy-2-phenyl-1-phenylethanone, dimethoxyhydroxy-acetophenone, substituted alpha-ketols, such as 2-methoxy-2-hydroxypropiophenone, for example, aromatic sulfonyl chlorides, such as 2-naphthylsulfonyl chloride, for example, and photoactive oximes, such as 1-phenyl-1,2-propanedione 2-(o-ethoxycarbonyl) oxime.

A feature of one further development, for all of the stated embodiments and variants, which makes the process of the invention particularly advantageous for the production of adhesive tapes, for example, is that the pressure sensitive adhesive is processed further from the melt, and that it is applied in particular to a backing.

As backing material, for adhesive tapes for example, it is possible in this context to use the materials which are customary and familiar to the skilled worker, such as films (polyesters, PET, PE, PP, BOPP, PVC), nonwovens, foams, wovens, and woven films, and also release paper (glassine, HDPE, LDPE). This list is not conclusive.

The crosslinking of the hotmelt pressure sensitive adhesives of the invention, when it takes place, is accomplished by brief UV irradiation in the range of 200-400 nm using standard commercial high-pressure or medium-pressure mercury lamps with an output, for example, of from 80 to 200 W/cm or by thermal crosslinking in a temperature range between 70-140° C. or by ionizing radiation, such as electron beam curing, for example. For UV crosslinking it may be appropriate to adapt the lamp output to the web speed or to carry out partial shading of the web, while running it slowly, in order to reduce the thermal stress to which it is subjected. The irradiation time is governed by the construction and output of the respective lamps.

The invention further relates to the use of the pressure sensitive adhesive thus obtained for an adhesive tape, in which case the acrylic pressure sensitive adhesive is present as a single-side or both-sides film on a backing.

As a result of the two different advantageous embodiments, the pressure sensitive adhesives of the invention can be divided up into two groups of different properties: In the first advantageous embodiment, the enhancement of cohesion comes about essentially through physical interactions between the macromolecules. These interactions can be undone by thermal energy and/or by introducing moisture, so that the operation of enhancing the cohesion is reversible. The second advantageous embodiment is chemically irreversibly crosslinked, so that the corresponding pressure sensitive adhesives of the invention are distinguished by high thermal stability with good properties in respect of their thermal shear strength. A substantial advantage of the invention as compared with the prior art is that, through appropriate choice of the functional groups, the pressure sensitive adhesives of the invention cover the spectrum from reversible to irreversible increase of the cohesion of the pressure sensitive adhesives, so that the pressure sensitive adhesive can be optimally matched to the particular end use.

The intention is to illustrate the invention below by a number of examples, without thereby wishing to subject it to any unnecessary restriction.

As a function of the desired technical adhesive properties of the acrylic hotmelts, a selection of acrylic and vinylic monomers is made. Quantities, proportions, and percentage fractions are based on the total amount of the monomers.

Examples 1.1 to 1.7 here described the first advantageous embodiment, examples 2.1 to 2.12 the second advantageous embodiment of the invention.

### EXAMPLES

Test Methods

The following test methods were employed for evaluating the technical adhesive properties of the PSAs prepared. For testing, films made of polyethylene glycol terephthalate (Examples 1 to 6) or siliconized release papers (Examples 7 to 12) were coated with adhesive at a rate of 50 g/m².

Shear Strength (Test A1, A2, A3)

A strip of the adhesive tape, 13 mm wide, was applied to a smooth, cleaned steel surface. The application area was 20 mm×13 mm (length×width). The following procedure was then undertaken:

Test A1: At room temperature, a 1 kg weight was fastened to the adhesive tape and the time recorded until the weight fell off.

Test A2: At room temperature, a 2 kg weight was fastened to the adhesive tape and the time recorded until the weight fell off.

Test A3: At 70° C., a 1 kg weight was fastened to the adhesive tape and the time recorded until the weight fell off.

The shear stability times measured are each reported in minutes and correspond to the average of three measurements.

180° Bond strength test (Test B)

A strip, 20 mm wide, of an acrylate pressure adhesive applied as a film to a polyester was applied to steel plates. The PSA strip was pressed onto the substrate twice using a 2 kg weight. The adhesive tape was then immediately peeled from the substrate at 300 mm/min and at an angle of 180°. The steel plates were washed twice with acetone and once with isopropanol. All measurements were conducted at room temperature under climate-controlled conditions.

The results of the measurements are reported in N/cm and are averaged from three measurements.

Rolling Ball (Test C)

An adhesive strip, 25 mm wide, is placed on a measuring rail with the side bearing the test adhesive downward. When the blocking device is released, a measuring ball made of V2A steel, with a diameter of 11 mm, rolls down the ramp and along a horizontal area coated with the adhesive.

The traveled distance on the film of adhesive, in mm, serves as a measure of the tack.

Gel Index (Test D)

After careful drying, the solvent-free samples of adhesive are welded into a pouch of polyethylene nonwoven (Tyvek web). The difference in the weight of the samples before extraction and after extraction with toluene is used to determine the gel index, in other words the toluene-insoluble weight fraction of the polymer.

Preparation of the Samples

The acrylates, methacrylates, and styrene used are available commercially. Benzoin acrylate was prepared in accordance with DE 27 43 979 A1. The monomers were purified by distillation before being used.

Preparation of the Trithiocarbonate:

Trithiocarbonate (V) as a regulator was prepared in accordance with Macromolecules 2000, 33, 243-245 and Synth. Commun. 1988, 18, 1531-1536.

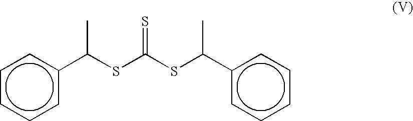

Preparation of the Difunctional Alkoxyamine (VI):

A procedure was followed in analogy to the experimental instructions from Journal of American Chemical Society, 121, 16, 3904-3920, 1999. 1,4-Divinylbenzene and nitroxide (VII) were used as starting materials.

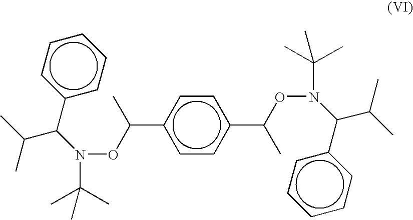

Preparation of the Nitroxide (VII) (2,2,5-trimethyl-4-phenyl-3-azahexane 3-nitroxide):

A procedure was followed in analogy to the experimental instructions from Journal of American Chemical Society, 121, 16, 3904-3920, 1999.

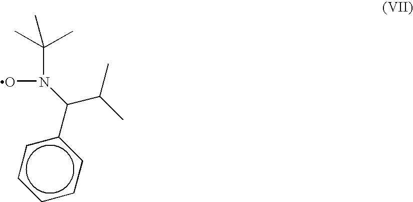

Procedure for the Polymerizations

Trithiocarbonate-Functionalized Polystyrene (A):

A 500 ml Schlenk vessel was charged with 400 ml of styrene and 3.47 g of the trithiocarbonate (V) (0.01172 mol), the vessel was degassed three times and then the polymerization was conducted under argon. For initiation the reaction mixture was heated to 110° C. and polymerized for 30 h with stirring. For isolation the reaction mixture was cooled to RT and the polymer was dissolved in 1000 ml of dichloromethane and then precipitated from 7.5 L of methanol with vigorous stirring. The precipitate was filtered off on a frit and then analyzed via GPC (Mₙ=34,200, M_{w/n}=1.17).

Trithiocarbonate-Functionalized Polymethyl Methacrylate (B):

A 1,000 ml Schlenk vessel was charged with 351 g of methyl methacrylate, 500 ml of toluene, 1.34 g of the trithiocarbonate (V) (0.0056 mol) and 1.00 g (0.0037 mol) of 1,1′-azobis(1-cyclohexanecarbonitrile) (Vazo 88™ from Du Pont), the vessel was degassed three times and then the polymerization was conducted under argon. For initiation the reaction mixture was heated to 80° C. and polymerized for 4 h with stirring. For isolation the reaction mixture was cooled to RT and the polymer was dissolved in 800 ml of dichloromethane and then precipitated from 8.0 L of methanol with vigorous stirring. The precipitate was filtered off on a frit and then analyzed via GPC (Mₙ=27,500, M_{w/m}=1.30).

General Procedure of the Polymerizations for Examples 2.7 to 2.12 (C):

A mixture of the alkoxyamine (VI) and the nitroxide (VII) (10 mol % with respect to alkoxyamine (VI)) are mixed with the monomers A and C, the resulting mixture being degassed several times with cooling to −78° C. and then heated at 110° C. under pressure in a closed vessel. After a reaction time of 36 h, monomer B is added and polymerization is continued at this temperature for 24 h. The molecular weight determination and the measurement of the polydispersity took place via GPC.

Block Copolymers

### Comparative Example 1.1

A reactor conventional for free-radical polymerizations was charged with 32 g of trithiocarbonate-functionalized polystyrene (A), 357 g of n-butyl acrylate and 0.12 g of azoisobutyronitrile (AIBN). After argon had been passed through the reactor for 20 minutes and the reactor had been degassed twice, it was heated to 60° C. with stirring and held at this temperature for 24 h.

For isolation, the reaction mixture was cooled to RT and the block copolymer PS-PBuA-PS was analyzed via GPC (Mₙ=181,000, M_{w/n}=1.39).

The block copolymer was subsequently coated from solution at 50 g/m² onto a siliconized release paper and then dried at 120° C. for 15 minutes. To analyze the technical adhesive properties, test methods A and B were carried out.

### Comparative Example 1.2

A reactor conventional for free-radical polymerizations was charged with 32 g of trithiocarbonate-functionalized polystyrene (A), 447 g of 2-ethylhexyl acrylate and 0.12 g of azoisobutyronitrile (AIBN). After argon had been passed through the reactor for 20 minutes and the reactor had been degassed twice, it was heated to 60° C. with stirring and held at this temperature for 24 h.

For isolation, the reaction mixture was cooled to RT and the block copolymer PS-PEHA-PS was analyzed via GPC (Mₙ=169,000, M_{w/n}=1.38).

The block copolymer was subsequently coated from solution at 50 g/m² onto a siliconized release paper and then dried at 120° C. for 15 minutes. To analyze the technical adhesive properties, test methods A and B were carried out.

### Example 1.3

A reactor conventional for free-radical polymerizations was charged with 32 g of trithiocarbonate-functionalized polystyrene (A), 352 g of n-butyl acrylate, 7 g of acrylic acid and 0.12 g of azoisobutyronitrile (AIBN). After argon had been passed through the reactor for 20 minutes and the reactor had been degassed twice, it was heated to 60° C. with stirring and held at this temperature for 24 h.

For isolation, the reaction mixture was cooled to RT and the block copolymer PS-P(BuA/AA)-PS was analyzed via GPC (Mₙ=174,000, M_{w/n}=1.51).

The block copolymer was subsequently coated from solution at 50 g/m² onto a siliconized release paper and then dried at 120° C. for 15 minutes. To analyze the technical adhesive properties, test methods A and B were carried out.

### Example 1.4

A reactor conventional for free-radical polymerizations was charged with 32 g of trithiocarbonate-functionalized polystyrene (A), 442 g of 2-ethylhexyl acrylate, 4.5 g of N-tert-butylacrylamide and 0.12 g of azoisobutyronitrile (AIBN). After argon had been passed through the reactor for 20 minutes and the reactor had been degassed twice, it was heated to 60° C. with stirring and held at this temperature for 24 h.

For isolation, the reaction mixture was cooled to RT and the block copolymer PS-P(EHA/NTBAM)-PS was analyzed via GPC (Mₙ=173,000, M_{w/n}=1.47).

The block copolymer was subsequently coated from solution at 50 g/m² onto a siliconized release paper and then dried at 120° C. for 15 minutes. To analyze the technical adhesive properties, test methods A and B were carried out.

### Example 1.5

A reactor conventional for free-radical polymerizations was charged with 32 g of trithiocarbonate-functionalized polystyrene (A), 352 g of n-butyl acrylate, 7 g of hydroxyethyl acrylate and 0.12 g of azoisobutyronitrile (AIBN). After argon had been passed through the reactor for 20 minutes and the reactor had been degassed twice, it was heated to 60° C. with stirring and held at this temperature for 24 h.

For isolation, the reaction mixture was cooled to RT and the block copolymer PS-P(BuA/HEA)-PS was analyzed via GPC (Mₙ=178,000, M_{w/n}=1.48).

The block copolymer was subsequently coated from solution at 50 g/m² onto a siliconized release paper and then dried at 120° C. for 15 minutes. To analyze the technical adhesive properties, test methods A and B were carried out.

### Comparative Example 1.6

A reactor conventional for free-radical polymerizations was charged with 32 g of trithiocarbonate-functionalized polymethyl methacrylate (B), 357 g of n-butyl acrylate and 0.12 g of azoisobutyronitrile (AIBN). After argon had been passed through the reactor for 20 minutes and the reactor had been degassed twice, it was heated to 60° C. with stirring and held at this temperature for 24 h.

For isolation, the reaction mixture was cooled to RT and the block copolymer PMMA-PBuA-PMMA was analyzed via GPC (Mₙ=173,000, M_{w/n}=1.43).

The block copolymer was subsequently coated from solution at 50 g/m² onto a siliconized release paper and then dried at 120° C. for 15 minutes. To analyze the technical adhesive properties, test methods A and B were carried out.

### Example 1.7

A reactor conventional for free-radical polymerizations was charged with 32 g of trithiocarbonate-functionalized polymethyl methacrylate (B), 352 g of n-butyl acrylate, 7 g of acrylic acid and 0.12 g of azoisobutyronitrile (AIBN). After argon had been passed through the reactor for 20 minutes and the reactor had been degassed twice, it was heated to 60° C. with stirring and held at this temperature for 24 h.

For isolation, the reaction mixture was cooled to RT and the block copolymer PMMA-P(BuA/AA)-PMMA was analyzed via GPC (Mₙ=172,000, M_{w/n}=1.53).

The block copolymer was subsequently coated from solution at 50 g/m² onto a siliconized release paper and then dried at 120° C. for 15 minutes. To analyze the technical adhesive properties, test methods A and B were carried out.

### Comparative Example 2.1

A reactor conventional for free-radical polymerizations was charged with 32 g of trithiocarbonate-functionalized polystyrene (A), 357 g of n-butyl acrylate and 0.12 g of azoisobutyronitrile (AIBN). After argon had been passed through the reactor for 20 minutes and the reactor had been degassed twice, it was heated to 60° C. with stirring and held at this temperature for 10 h.

For isolation, the reaction mixture was cooled to RT and the block copolymer PS-PBuA-PS was dissolved in 750 ml of dichloromethane and then precipitated from 6.0 L of methanol (cooled to −78° C.) with vigorous stirring. The precipitate was filtered off on a cooled frit and then analyzed via GPC (Mₙ=180,000, M_{w/n}=1.39).

100 g of the block copolymer were dissolved in 200 g of toluene and then 25 weight fractions of Foral 85™ (from Hercules) and 5 weight fractions of Catenex 945™ (from Shell) were added. The compounded mass was coated from solution at 50 g/m² onto a siliconized release paper and then dried at 120° C. for 15 minutes. To analyze the technical adhesive properties, test methods A, B and C were carried out.

### Comparative Example 2.2

A reactor conventional for free-radical polymerizations was charged with 32 g of trithiocarbonate-functionalized polystyrene (A), 447 g of 2-ethylhexyl acrylate and 0.12 g of azoisobutyronitrile (AIBN). After argon had been passed through the reactor for 20 minutes and the reactor had been degassed twice, it was heated to 60° C. with stirring and held at this temperature for 10 h.

For isolation, the reaction mixture was cooled to RT and the block copolymer PS-PEHA-PS was dissolved in 750 ml of dichloromethane and then precipitated from 6.0 L of methanol (cooled to −78° C.) with vigorous stirring. The precipitate was filtered off on a cooled frit and then analyzed via GPC (Mₙ=169,000, M_{w/n}=1.38).

100 g of the block copolymer were dissolved in 200 g of toluene and then 25 weight fractions of Foral 85™ (from Hercules) and 5 weight fractions of Catenex 945™ (from Shell) were added. The compounded mass was coated from solution at 50 g/m² onto a siliconized release paper and then dried at 120° C. for 15 minutes. To analyze the technical adhesive properties, test methods A, B and C were carried out.

### Example 2.3

A reactor conventional for free-radical polymerizations was charged with 32 g of trithiocarbonate-functionalized polystyrene (A), 355 g of n-butyl acrylate, 2 g of hydroxyethyl acrylate and 0.12 g of azoisobutyronitrile (AIBN). After argon had been passed through the reactor for 20 minutes and the reactor had been degassed twice, it was heated to 60° C. with stirring and held at this temperature for 10 h.

For isolation, the reaction mixture was cooled to RT and the block copolymer PS-P(BuA/HEA)-PS was dissolved in 750 ml of dichloromethane and then precipitated from 6.0 L of methanol (cooled to −78° C.) with vigorous stirring. The precipitate was filtered off on a cooled frit and then analyzed via GPC (Mₙ=174,000, M_{w/n}=1.51).

100 g of the block copolymer were dissolved in 200 g of toluene and then 25 weight fractions of Foral 85™ (from Hercules), 5 weight fractions of Catenex 945™ (from Shell) and 1.45 g of 1,6-diisocyanatohexane were added. The dissolved and blended adhesive was coated from solution at 50 g/m² onto a siliconized release paper and then dried at 120° C. for 15 minutes. To analyze the technical adhesive properties, test methods A, B and C were carried out.

### Example 2.4

A reactor conventional for free-radical polymerizations was charged with 32 g of trithiocarbonate-functionalized polystyrene (A), 442 g of 2-ethylhexyl acrylate, 4.5 g of acrylic acid and 0.12 g of azoisobutyronitrile (AIBN). After argon had been passed through the reactor for 20 minutes and the reactor had been degassed twice, it was heated to 60° C. with stirring and held at this temperature for 10 h.

For isolation, the reaction mixture was cooled to RT and the block copolymer PS-P(EHA/AA)-PS was dissolved in 750 ml of dichloromethane and then precipitated from 6.0 L of methanol (cooled to −78° C.) with vigorous stirring. The precipitate was filtered off on a cooled frit and then analyzed via GPC (Mₙ=173,000, M_{w/n}=1.47).

100 g of the block copolymer were dissolved in 200 g of toluene and then 25 weight fractions of Foral 85™ (from Hercules), 0.3 g of acetylaluminum acetonate (in solution 25 ml of toluene) and 5 weight fractions of Catenex 945™ (from Shell) were added. The compounded mass was coated from solution at 50 g/m² onto a siliconized release paper and then dried at 120° C. for 15 minutes. To analyze the technical adhesive properties, test methods A, B and C were carried out.

### Examples 2.5 and 2.5′

A reactor conventional for free-radical polymerizations was charged with 38 g of trithiocarbonate-functionalized polystyrene (A), 450 g of 2-ethylhexyl acrylate, 2.8 g of benzoin acrylate and 0.12 g of azoisobutyronitrile (AIBN). After argon had been passed through the reactor for 20 minutes and the reactor had been degassed twice, it was heated to 60° C. with stirring and held at this temperature for 10 h.

For isolation, the reaction mixture was cooled to RT and the block copolymer PS-P(EHA/BzA)-PS was dissolved in 750 ml of dichloromethane and then precipitated from 6.0 L of methanol (cooled to −78° C.) with vigorous stirring. The precipitate was filtered off on a cooled frit and then analyzed via GPC (Mₙ=191,000, M_{w/n}=1.45).

100 g of the block copolymer were dissolved in 200 g of toluene and then 25 weight fractions of Norsolene M1080™ (from Cray Valley), and 5 weight fractions of Catenex 945™ (from Shell) were added. The compounded mass was coated from solution at 50 g/m² onto a siliconized release paper, dried at 120° C. for 15 minutes, and irradiated at 20 m/min with a medium pressure mercury lamp (120 W/cm) with 4 passes through the lamp. As a reference, the unirradiated PSA tape was likewise tested (Example 5′). To analyze the technical adhesive properties, test methods A, B and C were carried out.

### Examples 2.6 and 2.6′

A reactor conventional for free-radical polymerizations was charged with 38 g of trithiocarbonate-functionalized polystyrene (A), 450 g of 2-ethylhexyl acrylate, 2.8 g of acrylated benzophenone (Ebecryl 36™, from UCB) and 0.12 g of azoisobutyronitrile (AIBN). After argon had been passed through the reactor for 20 minutes and the reactor had been degassed twice, it was heated to 60° C. with stirring and held at this temperature for 10 h.

For isolation, the reaction mixture was cooled to RT and the block copolymer PS-P(EHA/BnA)-PS was dissolved in 750 ml of dichloromethane and then precipitated from 6.0 L of methanol (cooled to −78° C.) with vigorous stirring. The precipitate was filtered off on a cooled frit and then analyzed via GPC (Mₙ=199,000, M_{w/n}=1.53).

100 g of the block copolymer were dissolved in 200 g of toluene and then 25 weight fractions of Norsolene M1080™ (from Cray Valley) and 5 weight fractions of Catenex 945™ (from Shell) were added. The compounded mass was freed from the solvent and then coated from the melt, as a hotmelt at 145° C., at 50 g/m² onto a siliconized release paper and irradiated at 20 m/min with a medium pressure mercury lamp (120 W/cm) with 4 passes through the lamp. As a reference, the unirradiated PSA tape was likewise tested (Example 6′). To analyze the technical adhesive properties, test methods A, B and C were carried out.

### Example 2.7

In analogy to the general procedure of polymerization (C), 0.739 g of the difunctional initiator (VI), 0.0287 g of the free nitroxide (VII), 480 g of n-butyl acrylate, 20 g of isoprene and 80 g of styrene were used. To isolate the polymer, the reaction mixture was cooled to RT and the block copolymer PS-P(BuA/I)-PS was dissolved in 750 ml of dichloromethane and then precipitated from 6.0 L of methanol (cooled to −78° C.) with vigorous stirring. The precipitate was filtered off on a cooled frit. GPC analysis gave (Mₙ=230,000, M_{w/n}=1.59).

100 g of the block copolymer prepared were dissolved in 200 g of toluene and then 25 weight fractions of Foral 85™ (from Hercules) and 5 weight fractions of Catenex 945™ were added. The compounded mass was coated from solution at 50 g/m² onto a siliconized release paper, dried in a drying oven at 120° C. and then crosslinked with an EB dose of 30 kGy with an acceleration voltage of 230 kV. For analysis of the technical adhesive properties, test methods A-D were conducted.

### Comparative Example 2.8

In analogy to the general procedure of polymerization (C), 0.739 g of the difunctional initiator (VI), 0.0287 g of the free nitroxide (VII), 500 g of n-butyl acrylate, and 80 g of styrene were used. To isolate the polymer, the reaction mixture was cooled to RT and the block copolymer PS-P(BuA)-PS was dissolved in 750 ml of dichloromethane and then precipitated from 6.0 L of methanol (cooled to −78° C.) with vigorous stirring. The precipitate was filtered off on a cooled frit. GPC analysis gave (Mₙ=220,000, M_{w/n}=1.45).

100 g of the block copolymer prepared were dissolved in 200 g of toluene and then 25 weight fractions of Foral 85™ (from Hercules) and 5 weight fractions of Catenex 945™ were added. The compounded mass was coated from solution at 50 g/m² onto a siliconized release paper, dried in a drying oven at 120° C. and then crosslinked with an EB dose of 30 kGy with an acceleration voltage of 230 kV. For analysis of the technical adhesive properties, test methods A-D were conducted.

### Example 2.9

In analogy to the general procedure of polymerization (C), 0.739 g of the difunctional initiator (VI), 0.0287 g of the free nitroxide (VII), 240 g of n-butyl acrylate, 240 g of 2-ethylhexyl acrylate, 20 g of isoprene and 80 g of styrene were used. To isolate the polymer, the reaction mixture was cooled to RT and the block copolymer PS-P(BA/EHA/I)-PS was dissolved in 750 ml of dichloromethane and then precipitated from 6.0 L of methanol (cooled to −78° C.) with vigorous stirring. The precipitate was filtered off on a cooled frit. GPC analysis gave (Mₙ=2,150,000, M_{w/n}=1.63). 100 g of the block copolymer prepared were dissolved in 200 g of toluene and then 25 weight fractions of Foral 85™ (from Hercules) and 5 weight fractions of Catenex 945™ were added. The compounded mass was coated from solution at 50 g/m² onto a siliconized release paper, dried in a drying oven at 120° C. and then crosslinked with an EB dose of 30 kGy with an acceleration voltage of 230 kV. For analysis of the technical adhesive properties, test methods A-D were conducted.

### Example 2.10

In analogy to the general procedure of polymerization (C), 0.739 g of the difunctional initiator (VI), 0.0287 g of the free nitroxide (VII), 480 g of 2-ethylhexyl acrylate, 20 g of isoprene and 80 g of styrene were used. To isolate the polymer, the reaction mixture was cooled to RT and the block copolymer PS-P(EHA/I)-PS was dissolved in 750 ml of dichloromethane and then precipitated from 6.0 L of methanol (cooled to −78° C.) with vigorous stirring. The precipitate was filtered off on a cooled frit. GPC analysis gave (Mₙ=2,080,000, M_{w/n}=1.57).

100 g of the block copolymer prepared were dissolved in 200 g of toluene and then 25 weight fractions of Foral 85™ (from Hercules) and 5 weight fractions of Catenex 945™ were added. The compounded mass was coated from solution at 50 g/m² onto a siliconized release paper, dried in a drying oven at 120° C. and then crosslinked with an EB dose of 30 kGy with an acceleration voltage of 230 kV. For analysis of the technical adhesive properties, test methods A-D were conducted.

### Example 2.11

In analogy to the general procedure of polymerization (C), 0.739 g of the difunctional initiator (VI), 0.0287 g of the free nitroxide (VII), 460 g of 2-ethylhexyl acrylate, 40 g of isoprene and 80 g of styrene were used. To isolate the polymer, the reaction mixture was cooled to RT and the block copolymer PS-P(EHA/I)-PS was dissolved in 750 ml of dichloromethane and then precipitated from 6.0 L of methanol (cooled to −780° C.) with vigorous stirring. The precipitate was filtered off on a cooled frit. GPC analysis gave (Mₙ=2,150,000, M_{w/n}=1.63).

100 g of the block copolymer prepared were dissolved in 200 g of toluene and then 25 weight fractions of Foral 85™ (from Hercules) and 5 weight fractions of Catenex 945™ were added. The compounded mass was coated from solution at 50 g/m² onto a siliconized release paper, dried in a drying oven at 120° C. and then crosslinked with an EB dose of 30 kGy with an acceleration voltage of 230 kV. For analysis of the technical adhesive properties, test methods A-D were conducted.

### Example 2.12

In analogy to the general procedure of polymerization (C), 0.739 g of the difunctional initiator (VI), 0.0287 g of the free nitroxide (VII), 480 g of 2-ethylhexyl acrylate, 20 g of isoprene and 120 g of styrene were used. To isolate the polymer, the reaction mixture was cooled to RT and the block copolymer PS-P(EHA/I)-PS was dissolved in 750 ml of dichloromethane and then precipitated from 6.0 L of methanol (cooled to −78° C.) with vigorous stirring. The precipitate was filtered off on a cooled frit. GPC analysis gave (Mₙ=2,460,000, M_{w/n}=1.68).

100 g of the block copolymer prepared were dissolved in 200 g of toluene and then 25 weight fractions of Foral 85™ (from Hercules) and 5 weight fractions of Catenex 945™ were added. The compounded mass was coated from solution at 50 g/m² onto a siliconized release paper, dried in a drying oven at 120° C. and then crosslinked with an EB dose of 30 kGy with an acceleration voltage of 230 kV. For analysis of the technical adhesive properties, test methods A-D were conducted.

Results

### Examples 1.1 to 1.5

The table below lists the technical adhesive properties of these compositions.

TABLE 1

| | | | BS-Steel |
|---|---|---|---|
| Example | SST RT/A1 | SST RT/A2 | [N/cm]/B |
| 1.1 | +10000 | 164 | 2.6 |
| 1.2 | +10000 | 68 | 2.9 |
| 1.3 | +10000 | +10000 | 4.0 |
| 1.4 | +10000 | 2375 | 3.4 |
| 1.5 | +10000 | 4486 | 3.6 |

Application rate: 50 g/m².
SST: Shear stability times [min]
RT: Room temperature
BS: Bond strength on steel

Examples 1.1 and 1.2 are conventionally produced polystyrene-polyacrylate-polystyrene PSAs. With a shear weight of 1 kg, no great differences in shear strength are evident. Only with a greater load is it possible to tease out the differences. With a 2 kg load, the shear strength rises markedly with Examples 1.3 to 1.5 owing to the cohesion-enhancing comonomers acrylic acid, N-tert-butylacrylamide and hydroxyethyl acrylate.

Moreover, the high cohesion is achieved without any crosslinking whatsoever.

### Examples 1.6 and 1.7

Table 2 below lists the technical adhesive properties of these examples.

TABLE 2

| | | | BS-Steel |
|---|---|---|---|
| Example | SST RT/A1 | SST RT/A2 | [N/cm]/B |
| 1.6 | +10000 | 95 | 2.8 |
| 1.7 | +10000 | +10000 | 3.2 |

Application rate: 50 g/m².
SST: Shear stability times [min]
RT: Room temperature
BS: Bond strength on steel

The comparison of Examples 1.6 and 1.7 shows that with PMMA end blocks as well an enhancement of cohesion is obtained by modifying the middle block. Here again, in Examples 1.7 the shear strength in the 20 N test rises markedly.

### Examples 2.1 to 2.4

Table 3 below lists the technical adhesive properties of these compositions.

TABLE 3

| | | SST | BS-steel | |
|---|---|---|---|---|
| Example | SST RT/A1 | 70° C./A3 | [N/cm]/B | RB [cm]/C |
| 2.1 | +10000 | 85 | 6.8 | 155 |
| 2.2 | +10000 | 45 | 7.0 | 180 |
| 2.3 | +10000 | 3585 | 5.5 | 210 |
| 2.4 | +10000 | 4350 | 5.2 | 235 |

Application rate: 50 g/m².
SST: Shear stability times [min]
RT: Room temperature
BS: Bond strength on steel
RB: Rolling ball test

Examples 2.1 and 2.2 are conventionally blended polystyrene-polyacrylate-polystyrene PSAs. Since no functional groups are present for crosslinking, good shear strength is achieved only at room temperature. Examples 2.3 and 2.4 contain hydroxyethyl acrylate or acrylic acid as comonomers in the middle block. Both the hydroxyl group and the carboxylic acid group can be utilized for crosslinking, so that in addition to the formation of domains by the polystyrene units it is also possible to employ a second crosslinking mechanism for the purpose of enhancing the cohesion (shear strength). Examples 2.3 was crosslinked thermally using a difunctional isocyanate, Example 2.4 using an aluminum chelate. The shear stability times at 70° C. show a markedly increased cohesion for the additionally crosslinked adhesives.

### Examples 2.5 and 2.6

Table 4 below lists the technical adhesive properties of these examples.

TABLE 4

| | | SST | BS-steel | |
|---|---|---|---|---|
| Example | SST RT/A1 | 70° C./A3 | [N/cm]/B | RB [cm]/C |
| 2.5 | +10000 | 2890 | 5.5 | 195 |
| 2.6 | +10000 | 2565 | 5.7 | 205 |
| 2.5′ | +10000 | 125 | 6.3 | 140 |
| 2.6′ | +10000 | 145 | 6.5 | 155 |

Application rate: 50 g/m².
SST: Shear stability times [min]
RT: Room temperature
BS: Bond strength on steel
RB: Rolling ball test

The examples show that photoinitiators as well can be copolymerized randomly into the middle block. Furthermore, PMMAs are also suitable as end blocks for stabilization and domain formation. By UV irradiation it is possible to crosslink the middle block efficiently and, therefore, the thermal shear strength is raised markedly in turn (see Comparison of Examples 2.5 and 2.6 with 2.5′ and 2.6′). Examples 2.6 was coated as a hotmelt and illustrates the possibility of processing these block copolymers from the melt.

### Examples 2.7 and 2.8

Table 5 illustrates the results of the technical adhesive evaluations from test methods A-D.

TABLE 5

| | | | | | | Gel |
|---|---|---|---|---|---|---|
| | | SST | SST | BS-steel | RB | index |
| Ex. | Polymer | RT/A1 | 70° C./A3 | [N/cm]/B | [cm]/C | [%] |
| 2.7 | PS-P(BA/I)-PS | +10000 | 1265 | 6.1 | 280 | 35 |
| 2.8 | PS-PBA-PS | +10000 | 245 | 6.4 | 245 | 10 |

Application rate: 50 g/m²; Electron beam dose 30 kGy
SST: Shear stability times [min]
RT: Room temperature
BS: Bond strength on steel
RB: Rolling ball test

A comparison of Examples 2.7 and 2.8 shows that by introducing the double bonds along the middle block there is a distinct improvement in electron beam crosslinkability. With an EB dose of 30 kGy, Example 2.7 achieves a gel index of 35%, Comparative Example 2.8 without double bonds a gel index of 10%. As a result of the more efficient crosslinking there is an increase in the cohesion, particularly under hot conditions. As a result of the formation of the hard polystyrene domains and as a result of the efficient electron beam crosslinking, therefore, it is possible to produce pressure sensitive adhesives possessing high shear strength.

### Examples 2.9 to 2.12

Table 6 illustrates the results of the technical adhesive evaluations from test methods A-D.

TABLE 6

| | | | SST | | | Gel |
|---|---|---|---|---|---|---|
| | | SST | 70° C./ | BS-steel | RB | index |
| Ex. | Polymer | RT/A1 | A3 | [N/cm]/B | [cm]/C | [%] |
| 2.9 | PS-P(BA/EHA/I)- | +10000 | 1455 | 6.3 | 275 | 38 |
| | PS | | | | | |
| 2.10 | PS-P(EHA/I)-PS | +10000 | 1050 | 6.6 | 220 | 40 |
| 2.11 | PS-P(EHA/I)-PS | +10000 | 3430 | 6.0 | 320 | 52 |
| 2.12 | PS-P(EHA/I)-PS | +10000 | 2825 | 6.0 | 330 | 37 |

Application rate: 50 g/m²; Electron beam dose 30 kGy
SST: Shear stability times [min]
RT: Room temperature
BS: Bond strength on steel
RB: Rolling ball test

Examples 2.9 to 2.12 show the variability of the pressure sensitive adhesives of the invention. In examples 2.9 a middle block polymerized randomly from butyl acrylate, 2-ethylhexyl acrylate and isoprene was used. In Example 2.11 the fraction of double bonds in the middle block was raised. After electron beam crosslinking, the gel index again underwent a marked increase as compared with the other examples. Polymers with relatively long PS end blocks can also be used as elastomers for pressure sensitive adhesives.

1. A pressure sensitive adhesive based on block copolymers of the general type P(B)-P(A/C)-P(B), each block copolymer being composed of one middle copolymer block P(A/C) and two end polymer blocks P/(B), characterized in that
P(A/C) represents a copolymer of the monomers A and C where the polymer P(A/C) possesses a glass transition temperature of from 0° C. to −80° C., component C possessing at least one functional group which behaves inertly in a free-radical polymerization reaction and which serves to raise the cohesion of the block copolymer,
P(B) represents a polymer of the monomers B where the polymer P(B) possesses a glass transition temperature of from 20° C. to 175° C.,
the polymer block P(B) is insoluble in the copolymer block P (A/C), and the blocks P(B) and P(A/C) are immiscible.

2. The pressure sensitive adhesive of claim 1, characterized in the cohesion-enhancing effect of the copolymer P(A/C) is brought about by bonds between the individual block copolymers P(B)-P(A/C)-P(B), with the functional group of one block copolymer macromolecule of the monomers C entering into interaction with at least one further block copolymer macromolecule.

3. The pressure sensitive adhesive of one of the preceding claims, characterized in that the functional group of the monomers C brings about the enhancement of cohesion by means of dipole/dipole interactions and/or hydrogen bonds.

4. The pressure sensitive adhesive of one of the preceding claims, characterized in that the functional group of the monomers C is a carboxylic acid group, a hydroxyl group or a tert-butyl group.

5. The pressure sensitive adhesive of one of the preceding claims, characterized in that as monomers C at least one compound from the following group is used: acrylic acid, hydroxyethyl acrylate, hydroxypropyl acrylate, methacrylic acid, methyl methacrylate, hydroxyethyl methacrylate, hydroxypropyl methacrylate, tert-butyl acrylate, itaconic anhydride, itaconic acid, acrylamides, such as N-tert-butylacrylamide, N-isopropylacrylamide or dimethylacrylamide, for example, and maleic anhydride.

6. The pressure sensitive adhesive of at least one of claims 1 and 2, characterized in that the functional group of the monomers C brings about the enhancement in cohesion by means of a crosslinking reaction, where appropriate not until after prior activation.

7. The pressure sensitive adhesive of claim 6, characterized in that the crosslinking-capable functional group of the monomers C is an unsaturated group which is capable of radiation-chemical crosslinking, in particular by crosslinking which is brought about by UV irradiation or by irradiation with electron beams.

8. The pressure sensitive adhesive of at least one of claims 6 and 7, characterized in that the crosslinking-capable functional group of the monomers C is an unsaturated alkyl radical of from 3 to 8 carbon atoms which contains at least one C—C double bond.

9. The pressure sensitive adhesive of claims 6, characterized in that the crosslinking-capable functional group of the monomers C is a group which is capable of a crosslinking reaction by virtue of the influence of thermal energy.

10. The pressure sensitive adhesive of at least one of claims 6 to 9, characterized in that the crosslinking-capable functional group of the monomers C is a hydroxyl, a carboxyl, an epoxy, an acid amide, an isocyanato or an amino group.

11. The pressure sensitive adhesive of at least one of claims 6 to 10, characterized in that as monomers C use is made of at least one compound of the following general formula 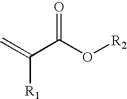
where R₁═H or CH₃ and —OR₂ represents or contains the functional group according to one of the above claims.

12. The pressure sensitive adhesive of at least one of the preceding claims, characterized in that as monomers C use is made of at least one compound which lowers the glass transition temperature of the copolymer block P(A/C) to T_{g}<0° C.

13. The pressure sensitive adhesive of at least one of the preceding claims, characterized in that as monomers A use is made of at least one compound of the general formula 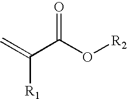
where R₁═H or CH₃ and R₂ is from the group of the branched or unbranched, saturated alkyl groups having 4-14 carbon atoms.

14. The pressure sensitive adhesive of at least one of the preceding claims, characterized in that as monomers B at least one monomer is used such that the resultant polymer blocks P(B) are capable of forming a 2-phase domain structure with the copolymer blocks P(A/C).

15. The pressure sensitive adhesive of at least one of the preceding claims, characterized in that the pressure sensitive adhesive possesses an average molecular weight of between 5,000 and 600,000 g/mol, in particular between 10,000 and 300,000 g/mol.

16. The pressure sensitive adhesive of at least one of the preceding claims, characterized in that the fraction of the polymer blocks P(B) lies between 10 and 60% by weight, in particular between 15 and 40% by weight, of the entire block copolymer.

17. The pressure sensitive adhesive of at least one of the preceding claims, characterized in that the weight fraction of the monomers C in relation to that of the monomers A lies between 0.1 and 20, in particular between 0.5 and 5.

18. The pressure sensitive adhesive as claimed in at least one of the preceding claims, characterized in that the block copolymers are mixed with from 0 to 50% by weight, in particular with from 20 to 40% by weight, of a resin.

19. A process for preparing a pressure sensitive adhesive of at least one of the preceding claims, characterized in that, in the course of the preparation and/or processing operation, additives are added to the pressure sensitive adhesive, such as aging inhibitors, light stabilizers, ozone protectants, fatty acids, plasticizers, nucleators, blowing agents, accelerators and/or fillers.

20. A process for producing a pressure sensitive adhesive of at least one of the preceding claims, characterized in that the pressure sensitive adhesive is processed further from the melt, in that it is applied in particular to a backing.

21. The use of the pressure sensitive adhesive of at least one of the preceding claims for adhesive tape, with the acrylic pressure sensitive adhesive being present as a single-side or both-sides film on a backing.
